(19) United States
(12) Patent Application Publication
(10) Pub. No.: US 2004/0011889 A1
(43) Pub. Date: Jan. 22, 2004

(54) Leak-reduced pressure -controlled fuel injector

(76) Inventor: Friedrich Boecking, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/332,377

(22) PCT Filed: Apr. 26, 2002
(86) PCT No.: PCT/DE02/01541

(30) Foreign Application Priority Data
May 8, 2001 (DE) 101 22 245.9

(51) Int. Cl. F02M 59/00

(52) U.S. Cl. 239/533.2

(57) ABSTRACT

The invention relates to a device for injecting fuel into the combustion chamber of an internal combustion engine. A control unit (1) is provided, which contains a housing chamber (4) that is continuously acted on with highly pressurized fuel by means of an inlet from a reservoir (common rail). The highly pressurized fuel is continuously present in the control chamber (6) of a control valve body (5) by means of an inlet throttle (7), wherein the control valve body (5) opens or closes a nozzle inlet (14) to an injection nozzle. The housing chamber (4) of the control unit (1) contains a thrust transmitting member (21) that delimits the control chamber (6), and the thrust transmitting member (21) is supported with a flat face (23) against the housing (2) and contains an outlet throttle (28) that pressure-relieves the control chamber (6) and can be opened by means of a servo valve (24).

### TECHNICAL FIELD

Injection systems that are used in air-compressing internal combustion engines and function according to the common rail principle are subjected to extremely high operating pressures. High-pressure pumps are used to achieve and continuously maintain the operating pressure level. Part of the delivery output of the high-pressure pumps is spent by leakage losses, which can occur at the moving components of fuel injectors of such injection systems that are used to inject the highly pressurized fuel into the combustion chamber of an internal combustion engine. The necessary delivery output of a high-pressure pump represents a criterion that influences its size.

### PRIOR ART

DE 197 15 234 A1 relates to a solenoid valve-controlled direct-injecting fuel injection valve for reservoir injection systems of multicylinder internal combustion engines. A supply line to a spring-loaded nozzle needle is provided, which can be closed by means of a control piston that functions as a valve. A nozzle needle spring that is supported in a spring chamber presses the nozzle needle against its needle seat. A solenoid valve and a control chamber, which is disposed at the back end of the control piston under system pressure, are also provided. This solenoid valve can connect the control chamber to a relief line and at the same time can cancel the closing of the supply line leading to the nozzle needle by means of a high-pressure valve disposed at the control piston. A throttled line connection is provided as a bypass between the supply line and the relief line; the line connection contains a leakage valve, which is connected to the solenoid valve and can shut off the line connection during the injection.

### DEPICTION OF THE INVENTION

The embodiment according to the invention offers the advantage that the control valve is integrated into the inlet from the high-pressure accumulation chamber (common rail) and the leakage is significantly reduced by preventing the pressure from dropping to a leakage pressure in the control valve. The control chamber acting on the valve body of the control component is advantageously encompassed by a cup-shaped thrust transmitting member, which is continuously subjected to the high pressure prevailing in the high-pressure accumulation chamber (common rail). The thrust transmitting member that delimits the control chamber rests with a flat seat against the housing of the control unit and is acted on by this spring element, which in addition to the high pressure prevailing in the housing chamber, holds the thrust transmitting member in contact with a wall of the housing chamber of this control unit.

Above the thrust transmitting member, there is a servo valve whose servo valve body can close and open an outlet throttle that relieves the pressure in the control chamber. With the embodiment according to the invention, the leakage losses are limited to the control volume quantity that flows through the outlet throttle when the control chamber is pressure-relieved after the servo valve is triggered. The integration of the thrust transmitting member into the inlet from the high-pressure accumulation chamber (common rail) results in the fact that the high pressure prevailing in the accumulation chamber pushes the thrust transmitting member into the flat seat, assisted by the spring contained underneath the thrust transmitting member. A pressure drop in the control component to the leakage pressure level can be prevented, which favorably influences the leakage in the control valve.

The flat seat of the thrust transmitting member, which delimits the control chamber, against the housing of the control unit seals the servo valve and the valve chamber encompassing the servo valve body off from the high pressure in the inlet from the high-pressure accumulation chamber. The control volume flowing out of the control chamber when it is being pressure-relieved is limited by the dimensioning of the outlet throttle and represents the only volume that flows out of the high-pressure part of the control unit. The high-pressure pump can therefore be designed in a considerably more favorable manner with regard to its delivery output, which favorably influences its manufacturing costs and size. A further advantage associated with reducing pump size lies in the reduction of the fuel temperature in the return of the injector. An excessive fuel temperature would require a cooling device to be provided, which represents an added expense that can be avoided with the reduction in pump size proposed according to the invention.

### DRAWING

The invention will be explained in detail below in conjunction with the drawing.

The sole FIGURE shows a section through a pressure-controlled control unit without a guidance leakage, which can be used, for example, in a nozzle-and-holder assembly.

### EMBODIMENT VARIANTS

The sole FIGURE shows a longitudinal section through the control unit embodied according to the invention, where the control unit 1 has a housing 2. The housing 2 of the control unit 1 contains a housing chamber 4, which is connected by means of an inlet 3 to a reservoir or high-pressure accumulation chamber (common rail) in which fuel that is acted on by a high-pressure pump is kept at an extremely high pressure level. By means of the inlet 3 to the housing chamber 4 of the control unit 1, this high pressure level generated in the reservoir or high-pressure accumulation chamber (common rail) also prevails in the housing chamber 4 of the control unit 1.

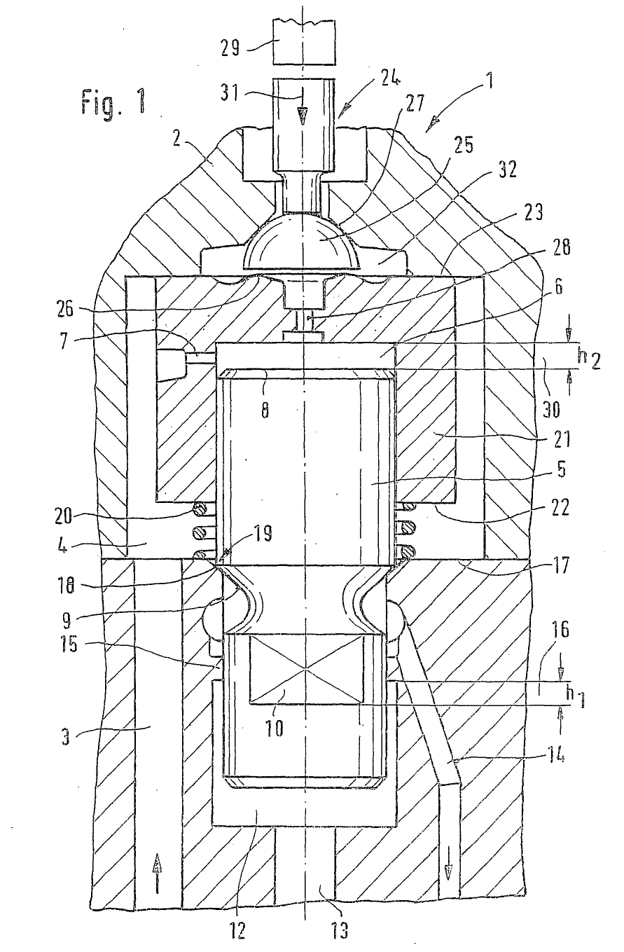

The housing chamber 4 of the control unit 1 according to the depiction in FIG. 1 contains a thrust transmitting member 21. The thrust transmitting member 21 is essentially embodied as a cup-shaped body that is open at one end and rests with a flat surface 23 against a wall of the housing 2 of the control unit 1. At the open end of the thrust transmitting member 21, a control valve body 5 is inserted into its inside and delimits a control chamber 6 together with the interior wall of the thrust transmitting member 21. On the one hand, the wall of the thrust transmitting member 21 is provided with an inlet valve 7 in the vicinity of the control chamber; on the other hand, the control chamber 6, which is delimited by the inside of the thrust transmitting member 21 and the end face 8 of the control valve body 5, can be pressure-relieved by means of an outlet throttle 28 embodied in the upper region of the thrust transmitting member 21. The pressure in the control chamber 6 is relieved by means of a servo valve 24 associated with the outlet throttle 28. At one end, a spring element 20, which acts on an annular end face 22 of the thrust transmitting member 21, presses the thrust transmitting member 21, which is contained in the housing chamber 4 of the control unit 1, against a flat seat 23 on a wall of the housing 2 of the control unit 1. The spring element 20, which is supported at one end against the annular end face 22 of the thrust transmitting member 21, is supported at the other end by the bottom of the housing chamber 4 in the housing 2 of the control unit 1. In addition, the fuel in the housing chamber 4, which is highly pressurized by means of the inlet 3 from the high-pressure accumulation chamber (common rail) and which acts on the annular end face 22 of the thrust transmitting member 21, causes the thrust transmitting member 21 to contact the flat seat 23 on the wall of the housing 2.

The action of the high pressure prevailing in the housing chamber 4 against the annular end face 22 of the thrust transmitting member 21 assures that the thrust transmitting member 21 contacts the flat seat 23 on the wall of the housing 2 of the control unit 1. In terms of production engineering, it is particularly easy to produce the flat seat 23 both on the wall of the housing 2 and on the corresponding side of the thrust transmitting member 21. For this purpose, an annular sealing surface 23 is provided between the thrust transmitting member 21 and the corresponding wall of the housing 2 of the control unit 1 and can be used to seal a valve chamber 32 of the servo valve 24 off from the housing chamber 4 and the high pressure level prevailing therein.

At one end, the control valve body 5 of the control unit 1 protrudes with its upper end face 8 into the control chamber 6, which receives a control volume flowing in via the inlet throttle 7, and this control volume can be opened and closed through actuation of the servo valve 24 by means of an actuator 29 that is only schematically depicted here. The control valve body 5 is also provided with an annular seat face 19, which extends into a constriction 9 on the control valve body 5. The constriction 9 is adjoined in the outflow direction by open flow surfaces 10 on the circumference of the control valve body 5, which can be embodied, for example offset from each other by 180° on the circumference of the control valve body 5. Opposite from the constriction 9 on the control valve body 5, the housing 2 of the control unit 1 contains an annular chamber 11 from which a nozzle inlet 14 branches off to a nozzle-and-holder assembly with an injection nozzle, not shown here. At one end, the control valve body 5 is centered and guided with its upper region in the thrust transmitting member 21; at the other end, beneath the constriction 9, the control valve body 5 is guided against housing surfaces 15. If the control chamber 6, which is delimited by the thrust transmitting member 21 and the upper end face 8 of the control valve body 5, is acted on by a highly pressurized control volume by means of the outlet throttle 7, then the control valve body 5 is moved into its seat face 18 in the bottom of the housing chamber 4. The annular seat face 19 on the control valve body 5 rests against the conically configured sealing seat face in the bottom of the housing 4 so that when the control valve body 5 is closed, i.e. when it is in contact with its sealing seat 18 in the housing, the nozzle inlet 14 is pressure-relieved into the leakage chamber 12 via the annular chamber 11 in the housing 2 of the control unit 1 and via the open flow surfaces 10. From the leakage chamber 12, the fuel flows on in the direction of the leakage outlet 13. The stroke height to which the end face 8 of the control valve body 5 travels inward when the control chamber 6 is pressure-relieved through actuation of the outlet throttle 28 is labeled with the reference numeral 30 (h₂). The stroke height 30 of the control valve body 5 when the control chamber 6 is pressure-relieved determines the size of a remaining overlap 16 of the open flow surfaces 10 at the circumference of the control valve body 5. The remaining overlap is labeled h₁. When the control valve body 5 has been placed against its sealing seat 18 in the housing chamber 4, i.e. when the control chamber 6 is acted on with pressure, it is necessary to assure that a region h₁ of the open flow surfaces 10 beneath the guide section 15 in the housing 2 permits an outflow of fuel via the nozzle inlet 14 into the annular chamber 11, into the leakage chamber 12, and thus on into the leakage outlet 13.

The outlet throttle 28 in the thrust transmitting member 21 for pressure-relieving the control chamber 6 is switched by means of a servo valve 24. The servo valve 24 is actuated by means of an actuator that is only schematically depicted here, for example a piezoelectric actuator 29, which actuates a servo valve body 25 of the servo valve 24 in accordance with the arrow direction 31. The servo valve body 25 of the servo valve 24 is embodied as hemispherical in the depiction in FIG. 1. The curved side of the hemispherical servo valve body 25 cooperates with a second seat 27 embodied in the housing 2 of the control unit 1, while the essentially flat side of the servo valve body 25 cooperates with a first seat 26 on top of the thrust transmitting member 21. The servo valve 24, which can be actuated by means of a piezoelectric actuator or a solenoid valve can switch the servo valve body 25 either into the first seat 26 in order to close the outlet throttle 28 or into its second seat in order to close the outlet in the housing 2 of the control unit 1. The servo valve body 25 is encompassed by a servo valve chamber 32, which is constituted on the one hand by a wall of the housing 2 of the control unit 1 and on the other hand by the thrust transmitting member 21. Since the servo valve body 25 of the servo valve 24 can only be switched back and forth between its first seat 26 and its second seat 27, the leakage losses are limited to the control volume that can be diverted from the control chamber 6 by means of the outlet throttle 28.

If high pressure prevails in the housing chamber 4 of the control unit 1 by means of the inlet 3 from the high-pressure accumulation chamber (common rail), then this high pressure flows through the inlet throttle 7 into the control chamber 6, which is delimited by the upper end 8 of the control valve body 5 and the inside of the thrust transmitting member 21. The high pressure building up in the control chamber 6 causes the control valve body 5 to travel into the sealing seat 18 embodied in the bottom of the housing chamber 4. In this position, the control valve body 5 closes the infeed from the housing chamber 4, via the constriction 9, into the annular chamber 11, and from there into the nozzle inlet 14 of a nozzle-and-holder assembly. This position, in which the control valve body 5 is positioned in its housing seat at the bottom of the housing chamber 4, permits the nozzle inlet 15 to be pressure-relieved via the annular chamber 11, the constriction 9 on the control valve body 5, the open flow surfaces 10, into the leakage chamber 12, and from there into the leakage outlet 13. The thrust transmitting member 21 that delimits the control chamber 6 is always acted on by the high pressure prevailing by means of the inlet 3 from the high-pressure accumulation chamber, which the flat seat 23 seals off from the servo valve chamber 32 of the servo valve 24. When the control chamber 6 is pressure-relieved by switching the control valve body 25 from its first seat 26 above the outlet throttle 28 into its second seat 27 embodied in the housing 2 of the control unit 1, then the control volume flows from the control chamber 6, through the outlet throttle 28, and into the servo valve chamber 32 so that the end face 8 of the control valve body 5 moves upward into the control chamber 6. At the same time, the servo valve chamber 32 is sealed at its second seat 27, which is closed by the curved part of the control valve body 25. On the other hand, if the actuator 29 actuates the control valve body 25 in the movement direction 31, then the control valve body 25 is placed with its flat side against the first seat 26 above the outlet throttle 28 in the thrust transmitting member 21 and closes this outlet throttle 28. Highly pressurized fuel continuously rushing into the control chamber 6 via the inlet throttle 7 produces a pressure increase 6 in the control chamber 6, which presses the control valve body 5 into its sealing seat 18 in the bottom of the housing chamber 4. At the same time, the nozzle inlet 14 is pressure-relieved into the leakage chamber 11 in the low-pressure region of the control unit 1 by means of the constriction 9, the annular chamber 11, and the open flow surfaces 10.

The integration of the control chamber 6 and the control valve 5 into a housing chamber 4 prevents the pressure level prevailing there from dropping to a leakage pressure level. The leakage pressure level only prevails in the low-pressure region of the control unit 1, i.e. underneath the open flow surfaces 10 in the leakage chamber 11 and in the leakage outlet 13. The annular sealing surface 23 in the form of a flat seat, which is disposed between the thrust transmitting member 21 and the corresponding wall of the housing 2 of the control unit 1, and the placement of the thrust transmitting member 21 against this sealing surface on the one hand by means of a spring element 20 and on the other hand by means of high pressure prevailing against the annular end face 22, result in an improved sealing of the housing chamber 4 for the prevention of leakage losses. In addition, the use of the servo valve 24 above the thrust transmitting member 21 to open or close the outlet throttle 28 of the control chamber 6 assures that only the control quantity flowing out of the control chamber 6 when it is pressure-relieved travels into the control valve chamber 32. In a way, the servo valve chamber 32 serves as a buffer for receiving fuel used as a control volume, which flows into the servo valve chamber 32 each time the servo valve body 25 is moved away from its first seat 26, thus opening the outlet throttle 28. Only the fuel volume, which flows out when the piezoelectric actuator 29 schematically depicted here actuates the servo valve 24 and which comes out of the control chamber 6 via the outlet throttle 28, represents a leakage. Since the leakage losses are limited to the control volume flowing out of the control chamber 6 when it is pressure-relieved, the control unit 1 produced according to the invention can be used to operate a fuel injection system, which can be equipped with a significantly smaller high-pressure pump. Previously necessary overdimensioning of the high-pressure pump in order to make up for leakage losses can now be eliminated since the leakage losses in the control unit proposed according to the invention are limited to the outlet volume of the control quantity emerging from the control chamber 6. A use of a smaller high-pressure pump to exert pressure on the high-pressure accumulation chamber and therefore via the inlet 3 of the housing chamber 4 of the control unit 1 proposed according to the invention also achieves a reduction of the fuel temperature. The reduction of the fuel temperature with the use of a smaller high-pressure pump has a very favorable influence on the injection behavior of the injection volume to be supplied by means of the nozzle inlet 14 of a nozzle-and-holder assembly.

1. A device for injecting fuel into the combustion chamber of an internal combustion engine, with a control unit (1) that contains a housing chamber (4), which is continuously acted on with highly pressurized fuel by means of an inlet from the high-pressure accumulation chamber (common rail), which fuel is present in a control chamber (6) of a control valve body (5) and in an inlet throttle (7), wherein the control valve body (5) opens or closes a nozzle inlet (14) to an injection nozzle, characterized in that the housing chamber (4) of the control unit (1) contains a thrust transmitting member (21) that delimits the control chamber (6), wherein the control chamber (6) can be pressure-relieved or acted on with pressure by means of a servo valve (24) that can be switched into two seats (26, 27).

2. The device for injecting fuel according to claim 1, characterized in that a spring element (20) pushes the thrust transmitting member (21) against a flat seat (23) embodied on the housing (2).

3. The device for injecting fuel according to claim 1, characterized in that the thrust transmitting member (21) protrudes with an annular end face (22) into the housing chamber (4).

4. The device according to claim 1, characterized in that a wall of the thrust transmitting member (21) contains an inlet throttle (7) to the control chamber (6) and an outlet throttle (28) of the control chamber (6).

5. The device according to claim 1, characterized in that a servo valve (24) is accommodated above the control chamber (6) and is associated with the outlet throttle (28).

6. The device according to claim 5, characterized in that the servo valve (24) has a servo valve body (25) that is embodied as essentially hemispherical.

7. The device according to claim 5, characterized in that the servo valve (24) closes a first seat (26) on top of the thrust transmitting member (21) or a second seat (27) in the housing (2) of the control unit (1).

8. The device according to claim 7, characterized in that the first seat (26) on top of the thrust transmitting member (21) is opened and closed by a flat part of the servo valve body (25) and the second seat (27) in the housing (2) of the control unit (1) is opened and closed by a curved surface of the servo valve body (25).

9. The device according to claim 1, characterized in that the housing chamber (4) of the control unit (1) has a sealing surface (18) embodied in it for a seat face (19) of the control valve body (5).

10. The device according to claim 1, characterized in that underneath a seat face (19), the control valve body (5) has a constriction (9), a nozzle inlet (14) in the housing (2) of the control unit (1) branches away opposite this constriction (9), and beneath the constriction (9) on the control valve body (5), open surfaces (10) are provided, which permit an outflow of fuel and through which fuel flows into the low-pressure region (12, 13) of the control unit (1) when the nozzle inlet (14) is pressure-relieved.
